(19) United States
(12) Patent Application Publication
(10) Pub. No.: US 2026/0175644 A1
(43) Pub. Date: Jun. 25, 2026

(54) VEHICLE HEAT MANAGEMENT DEVICE

(71) Applicant: TOYOTA JIDOSHA KABUSHIKI KAISHA, Toyota-shi (JP)

(72) Inventors: Daisuke SAKAMOTO, Toyota-shi (JP); Keita HIRANO, Toyota-shi (JP)

(73) Assignee: TOYOTA JIDOSHA KABUSHIKI KAISHA, Toyota-shi (JP)

(21) Appl. No.: 19/392,767

(22) Filed: Nov. 18, 2025

(30) Foreign Application Priority Data
Dec. 20, 2024 (JP) 2024-225801

(51) Int. Cl. B60H 1/00

(52) U.S. Cl. CPC B60H 1/00899

(57) ABSTRACT

The vehicle heat management device includes a control unit, and the control unit switches the switching unit so that the coolant flows from the first connecting portion to LT radiator and does not flow from the second connecting portion when the heating operation is performed based on the operation state of the air conditioner. On the other hand, in cases other than the heating operation, the switching unit is switched so that the coolant flows into LT radiator from the second connecting portion and does not flow into the first connecting portion.

### CROSS-REFERENCE TO RELATED APPLICATION

This application claims priority to Japanese Patent Application No. 2024-225801 filed on Dec. 20, 2024. The disclosure of the above-identified application, including the specification, drawings, and claims, is incorporated by reference herein in its entirety.

### BACKGROUND

### 1. Technical Field

The present disclosure relates to a vehicle heat management device.

### 2. Description of Related Art

Japanese Unexamined Patent Application Publication No. 2021-020486 (JP 2021-020486 A) discloses an in-vehicle heat management device that is configured such that, in a cooling mode, an air/refrigerant heat exchanger for performing heat exchange between air and refrigerant dissipates heat from refrigerant through an air/coolant heat exchanger for performing heat exchange between air and coolant, and in a heating mode, the air/coolant heat exchanger performs absorption of heat by coolant through the air/refrigerant heat exchanger.

### SUMMARY

In the technology of JP 2021-020486 A, in the cooling mode, heat can be dissipated from the refrigerant in the air/refrigerant heat exchanger to an air flow, and in the heating mode, coolant in the air/coolant heat exchanger can absorb heat from the air flow. However, in the two heat exchangers that are disposed adjacently to each other, the heat exchanger on a rearward side in a vehicle is affected by ambient temperature of the heat exchanger on a forward side in the vehicle, and also there is a temperature distribution in the heat exchanger on the forward side in the vehicle, and accordingly there is room for improvement to improve heat exchange efficiency.

The present disclosure has been made in light of the above circumstances, and accordingly an object thereof is to provide a vehicle heat management device that is capable of improving heat exchange efficiency of a heat exchanger on a vehicle rearward side out of two heat exchangers disposed adjacently to each other.

A vehicle heat management device according to a first aspect includes
a first heat exchanger that is disposed at a front portion of a vehicle,
a second heat exchanger that is disposed adjacently to a vehicle rearward side of the first heat exchanger, an air conditioner that performs air-conditioning inside of a vehicle cabin, using refrigerant that circulates through the first heat exchanger, and
a cooling circuit that includes an outflow portion that is connected to a refrigerant outlet of the second heat exchanger, a first connecting portion that is connected to a refrigerant inlet that is provided in an upper portion of the second heat exchanger, a second connecting portion that is connected to a refrigerant inlet that is provided in a middle portion of the second heat exchanger, and a switching unit that switches flow of the refrigerant between to the first connecting portion and to the second connecting portion based on an operation state of the air conditioner, the cooling circuit being connected to the second heat exchanger and circulating the refrigerant.

According to the first aspect, the switching unit is capable of switching a path of refrigerant of the second heat exchanger, between a path of refrigerant flowing from the first connecting portion to refrigerant outflow portion, and a path of refrigerant flowing from the second connecting portion to the refrigerant outflow portion, based on the operation state of the air conditioner. Thus, the second heat exchanger can be maximally utilized, and heat exchange efficiency of the heat exchanger on the vehicle rearward side between the two heat exchangers that are disposed adjacently to each other can be improved.

With the vehicle heat management device according to a second aspect, the vehicle heat management device according to the first aspect further includes a control unit that controls the switching unit based on the operation state of the air conditioner.

According to the second aspect, the control unit controls the switching unit based on the operation state of the air conditioner, such that the path of the refrigerant of the second heat exchanger can be changed to a path of refrigerant that is suitable for cooling, heating, or the like.

With the vehicle heat management device according to a third aspect, in the vehicle heat management device according to the second aspect, when the air conditioner is performing a heating operation, the control unit controls the switching unit such that refrigerant flows from the first connecting portion to the second heat exchanger.

According to the third aspect, in the heating operation, controlling the switching unit such that refrigerant flows from the first connecting portion to the second heat exchanger enables heat to be transferred to the first heat exchanger using the entire surface of the second heat exchanger, and accordingly heating performance of the air conditioner can be improved.

With the vehicle heat management device according to a fourth aspect, in the vehicle heat management device according to the second aspect or the third aspect, when the air conditioner is performing other than the heating operation, the control unit controls the switching unit such that refrigerant flows from the second connecting portion to the second heat exchanger.

According to the fourth aspect, when in an operation other than the heating operation, controlling the switching unit such that refrigerant flows into the second heat exchanger from the second connecting portion enables heat to be dissipated from the second heat exchanger, with reduced effects from a high-temperature portion of the first heat exchanger.

As described above, according to the present disclosure, a vehicle heat management device can be provided that is capable of improving heat exchange efficiency of a heat exchanger on a vehicle rearward side, out of two heat exchangers that are disposed adjacently to each other.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a schematic configuration of a vehicle heat management device according to an embodiment;

FIG. 2 is a perspective view showing a LT radiator;

FIG. 3 is a schematic diagram illustrating a switching state of a switching unit in winter;

FIG. 4 is a schematic diagram illustrating a switching state of a switching unit in summer;

FIG. 5 is a flowchart illustrating an example of a flow of processing performed by a control unit of the vehicle heat management device according to the present embodiment;

FIG. 6 is a diagram showing the temperature-distribution of HT radiator and LT radiator and the flow of the coolant of LT radiator when the heating operation is not performed; and

FIG. 7 is a diagram showing the temperature-distribution of HT radiator and LT radiator and the flow of the coolant of LT radiator in the heating operation.

### DETAILED DESCRIPTION OF EMBODIMENTS

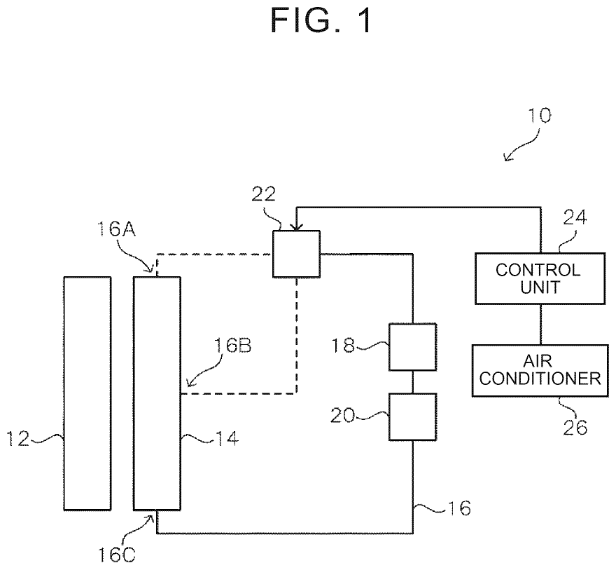

Hereinafter, an example of the embodiment of the present disclosure will be described in detail with reference to the drawings. FIG. 1 is a schematic diagram illustrating a schematic configuration of a vehicle heat management device 10 according to the present embodiment.

Vehicle heat management device 10 according to the present embodiment includes: HT (High Temperature) radiator 12 as an example of a first heat exchanger; and LT (Low Temperature) radiator 14 as an example of a second exchanger. HT radiator 12 and LT radiator 14 are disposed adjacently along the front-rear direction of the vehicle.

HT radiator 12 is disposed at a front portion of the vehicle. In the present embodiment, HT radiator 12 is a cross-flow type heat exchanger. HT radiator 12 cools batteries, an air conditioner, or the like as an exemplary cooling target. HT radiator 12 has a function of cooling a cooling target by circulating coolant as an exemplary refrigerant. HT radiator 12 is connected to a heater core (not shown) provided in the vehicle cabin, and has a function of heating the vehicle cabin by radiating heat of coolant from the heater core during heating. The refrigerant flowing through HT radiator 12 may be a refrigerant other than the coolant.

LT radiator 14 is disposed adjacently to the rear of HT radiator 12 vehicle. In the present embodiment, LT radiator 14 is a cross-flow type heat exchanger. LT radiator 14 is connected to a cooling circuit 16 through which coolant as an exemplary refrigerant flows. In the present embodiment, LT radiator 14 functions as a heat absorber during the heating operation, and heat absorbed by the heating is utilized. The refrigerant flowing through LT radiator 14 may be a refrigerant other than the coolant.

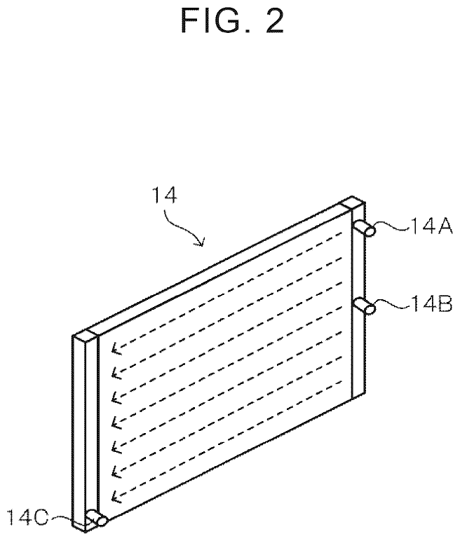

As shown in FIG. 2, LT radiator 14 includes two refrigerant inlet 14A, 14B at one end side in the vehicle width direction and one refrigerant outlet 14C at a lower portion at the other end side in the vehicle width direction. One refrigerant inlet 14A at one end in the vehicle-width direction is provided at an upper portion of LT radiator 14, and the other refrigerant inlet 14B is provided at a middle portion in the vertical direction of LT radiator 14. The middle portion is not limited to the middle in the up-down direction, and may be the upper side or the lower side of the middle.

In the present embodiment, LT radiator 14 is of a cross-flow type, and therefore coolant flows in from one of the two refrigerant inlet 14A, 14B at one end in the vehicle width-direction. As indicated by the dotted arrows in FIG. 2, the coolant flows through LT radiator 14. Then, the coolant flows out from the refrigerant outlet 14C at the lower portion at the other end in the vehicle width-direction.

As shown in FIG. 1, the cooling circuit 16 has, for example, a function of connecting the transaxle oil cooler 18 and the power control unit 20 as an example of a cooling target and allowing coolant to flow therethrough, thereby cooling the coolant. The cooling target of the cooling circuit 16 is not limited to the transaxle oil cooler 18 and the power control unit 20, and other cooling targets may be applied.

Cooling circuitry 16 includes an outflow portion 16C connected to a refrigerant outlet 14C of LT radiator 14, a switching unit 22 that switches the flow of refrigerant to the first connecting portion 16A and the second connecting portion 16B, a first connecting portion 16A connected to a refrigerant inlet 14A at an upper portion of LT radiator 14, and a second connecting portion 16B connected to a refrigerant inlet 14B at a middle portion of LT radiator 14.

The switching unit 22 includes a valve driven by an actuator or the like, and exclusively switches between the first connecting portion 16A and the second connecting portion 16B. The switching unit 22 is connected to the control unit 24, and the switching of the switching unit 22 is controlled under the control of the control unit 24.

The control unit 24 is connected to the above-described switching unit 22 and the air conditioner 26, has a function of controlling the air conditioner 26 in the vehicle cabin, and controls the switching unit 22 based on the operation state of the air conditioner 26. For example, the control unit 24 controls the switching unit 22 in accordance with the setting of the air conditioning, the outside air temperature, and the like.

The air conditioner 26 performs heating and cooling of the vehicle cabin. For example, the air conditioner 26 performs air-conditioning (heating) on the vehicle cabin using the refrigerant circulating in HT radiator 12. The heating may include heating using a heat pump in addition to heating using the coolant flowing through HT radiator 12 as a heat source. On the other hand, in cooling, the vehicle cabin is cooled using a known refrigerant cycle including a compressor, a condenser, an evaporator, an expansion valve, and the like.

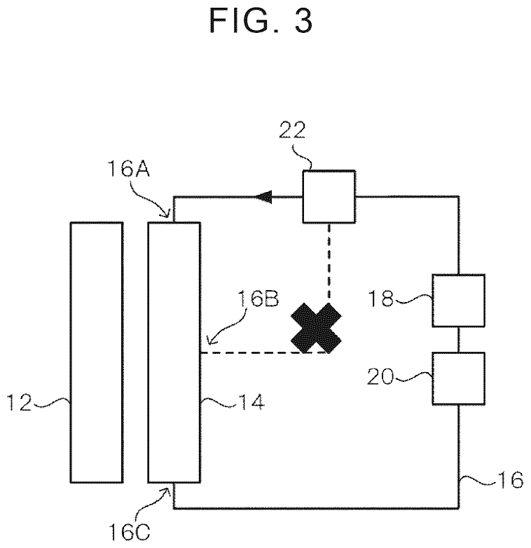

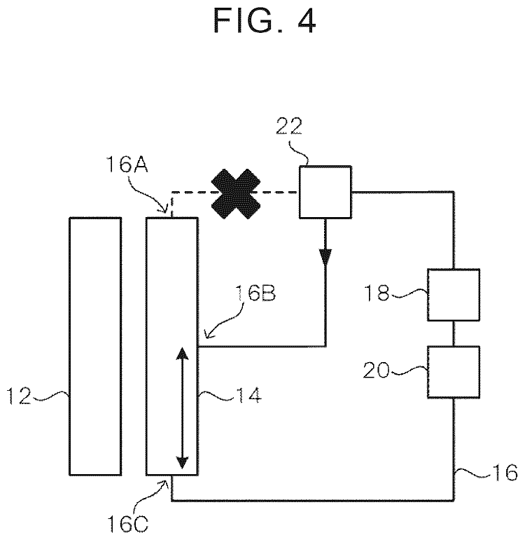

Here, the switching of the switching unit 22 will be described. FIG. 3 is a schematic diagram illustrating a switching state of the switching unit 22 in winter, and FIG. 4 is a schematic diagram illustrating a switching state of the switching unit 22 in summer.

In the heating operation in winter, as shown in FIG. 3, the switching unit 22 is switched so that the coolant flows from the first connecting portion 16A to LT radiator 14 and does not flow from the second connecting portion 16B.

By switching the switching unit 22 in this way, in the winter season, the whole surface of LT radiator 14 is used to absorb heat and utilize it for the heating performance. That is, the heat absorbed from the transaxle oil cooler 18 and the power control unit 20 to be cooled is transferred from LT radiator 14 to the neighboring HT radiator 12, so that the heat absorbed is utilized for the heating performance of the heater connected to HT radiator 12.

On the other hand, in cases other than the heating operation in summer, as shown in FIG. 4, the switching unit 22 is switched so that the coolant flows from the second connecting portion 16B to LT radiator 14 and does not flow from the first connecting portion 16A.

Except for the summer heating operation, the upper portion behind HT radiator 12 is at a higher temperature (e.g., about 80 degrees) than the lower portion, and the lower portion is at a lower temperature (e.g., about 60 degrees). Since most of the cooling targets to be cooled by LT radiator 14 are desired to be cooled at about 65 degrees, the upper part of LT radiator 14 receives the exhaust heat of HT radiator 12. On the other hand, the lower part of LT radiator 14 is heat dissipation. Therefore, by switching the switching unit 22 in this manner, the cooling performance is improved by cooling LT radiator 14 using the lower-temperature part of the neighboring HT radiator 12 in summer.

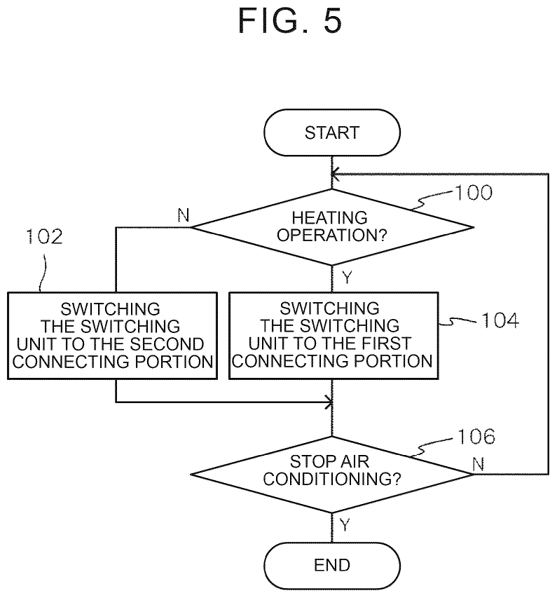

Next, a specific process performed by the control unit 24 of the vehicle heat management device 10 according to the present embodiment configured as described above will be described. FIG. 5 is a flowchart illustrating an example of a flow of processing performed by the control unit 24 of the vehicle heat management device 10 according to the present embodiment. Note that the process of FIG. 5 is started, for example, when an instruction to start the operation of air conditioning is given.

In step 100, the control unit 24 determines whether the heating operation is performed. The determination is made based on the operation state of the air conditioner 26 to determine whether or not the operation is a heating operation. For example, it may be determined whether the heating operation is performed based on the setting of the air conditioning or the outside air temperature. Alternatively, it may be determined whether or not the heat pump operation is performed. If the determination is negative, the process proceeds to step 102, and if affirmative, the process proceeds to step 104.

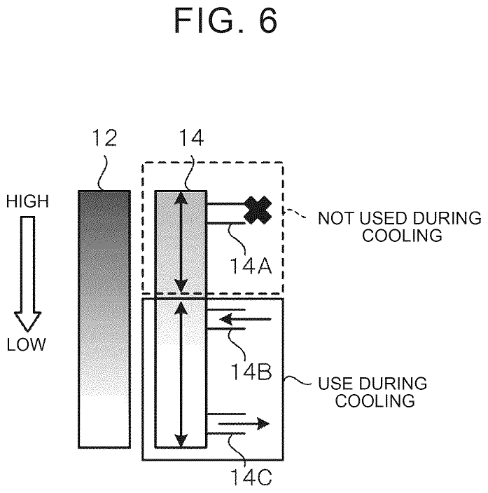

In step 102, the control unit 24 switches the switching unit 22 to the second connecting portion 16B, and the process proceeds to step 106. That is, in cases other than the heating operation such as in summer, as shown in FIG. 6, the upper portion of the rear of HT radiator 12 has a higher temperature than the lower portion, and the lower portion has a lower temperature. Therefore, the switching unit 22 is switched so that the coolant flows into LT radiator 14 from the refrigerant inlet 14B of the second connecting portion 16B and the coolant does not flow into the refrigerant inlet 14A of the first connecting portion 16A. As a result, LT radiator 14 can be cooled by using the lower-temperature part of the neighboring HT radiator 12, so that the cooling performance can be improved.

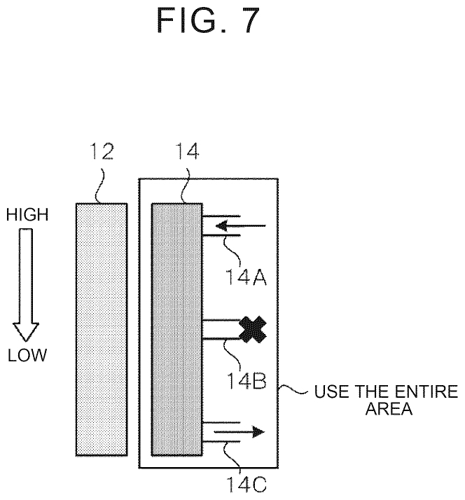

On the other hand, in step 104, the control unit 24 switches the switching unit 22 to the first connecting portion 16A, and the process proceeds to step 106. That is, in winter, as shown in FIG. 7, in order to utilize the heating performance by absorbing heat using the entire surface of LT radiator 14, the coolant flows into LT radiator 14 from the refrigerant inlet 14A of the first connecting portion 16A, and the switching unit 22 is switched so that the coolant does not flow from the refrigerant inlet 14B of the second connecting portion 16B. As a result, the heat absorbed by LT radiator 14 from the transaxle oil cooler 18 and the power control unit 20 to be cooled is transferred to the neighboring HT radiator 12, so that the heat absorbed can be utilized for the heating performance of the heater connected to HT radiator 12.

In step 106, the control unit 24 determines whether to stop the air conditioning. The determination is made, for example, as to whether or not an instruction to stop the operation of the air conditioning is given. When the determination is negative, the process returns to step 100 to repeat the above-described processing, and when the determination is affirmative, the series of processing ends.

As described above, in the vehicle heat management device 10 according to the present embodiment, since the control unit 24 controls the switching unit 22 based on the operation state of the air conditioner 26, LT radiator 14 can be utilized as much as possible, so that the heat exchanging efficiency of LT radiator 14 can be improved.

In the above-described embodiment, HT radiator 12 and LT radiator 14 are of a cross-flow type, but a down-flow type radiator may be used. In this case, for example, a center tank is provided in a middle portion in addition to the upper tank and the lower tank of the downflow radiator. Then, a refrigerant inlet 14A is provided in the upper tank to connect the first connecting portion 16A, a refrigerant inlet 14B is provided in the center tank to connect the second connecting portion 16B, and a refrigerant outlet is provided in the lower tank to connect the outflow portion 16C, whereby the same advantages as those of the above-described embodiment can be expected.

Further, the processing performed by the control unit 24 in the above-described embodiments may be software processing performed by executing a program, or hardware processing such as GPU (Graphics Processing Unit), ASIC (Application Specific Integrated Circuit), and FPGA (Field-Programmable Gate Array). Alternatively, the process may be performed by a combination of both software and hardware. Further, in the case of software processing, the program may be stored in various storage media and distributed.

Further, the present disclosure is not limited to the above, and it is needless to say that various modifications can be made without departing from the scope of the present disclosure.

What is claimed is:

1. A vehicle heat management device, comprising:
a first heat exchanger that is disposed at a front portion of a vehicle;
a second heat exchanger that is disposed adjacently to a vehicle rearward side of the first heat exchanger,
an air conditioner that performs air-conditioning inside of a vehicle cabin, using refrigerant that circulates through the first heat exchanger, and
a cooling circuit that includes an outflow portion that is connected to a refrigerant outlet of the second heat exchanger, a first connecting portion that is connected to a refrigerant inlet that is provided in an upper portion of the second heat exchanger, a second connecting portion that is connected to a refrigerant inlet that is provided in a middle portion of the second heat exchanger, and a switching unit that switches flow of the refrigerant between to the first connecting portion and to the second connecting portion based on an operation state of the air conditioner, the cooling circuit being connected to the second heat exchanger and circulating the refrigerant.

2. The vehicle heat management device according to claim 1, further comprising a control unit that controls the switching unit based on the operation state of the air conditioner.

3. The vehicle heat management device according to claim 2, wherein, when the air conditioner is performing a heating operation, the control unit controls the switching unit such that the refrigerant flows from the first connecting portion to the second heat exchanger.

4. The vehicle heat management device according to claim 2, wherein, when the air conditioner is performing other than a heating operation, the control unit controls the switching unit such that the refrigerant flows from the second connecting portion to the second heat exchanger.
